(19) United States
(12) Patent Application Publication
(10) Pub. No.: US 2020/0379967 A1
(43) Pub. Date: Dec. 3, 2020

(54) DATA MANAGEMENT APPARATUS, METHOD AND NON-TRANSITORY TANGIBLE MACHINE-READABLE MEDIUM THEREOF

(71) Applicant: BigObject Inc., Taipei City (TW)

(72) Inventor: Yi-Cheng HUANG, Taipei City (TW)

(21) Appl. No.: 16/506,852

(22) Filed: Jul. 9, 2019

(30) Foreign Application Priority Data
May 29, 2019 (CN) 201910456763.X

(51) Int. Cl. G06F 16/22; G06F 16/2455

(52) U.S. Cl. CPC G06F 16/2255; G06F 16/2456; G06F 16/2282

(57) ABSTRACT

A data management apparatus, method, and non-transitory tangible machine-readable medium thereof are provided. The data management apparatus includes a storage and a processor, wherein the processor is electrically connected to the storage. The storage stores a dimension table, wherein the dimension table is defined by a plurality of attributes, and a subset of the attributes is set to be an index attribute. The dimension table includes a plurality of members, and each of the members includes an index datum corresponding to the index attribute. The processor creates a last index for each distinct index datum among the plurality of index data, wherein each of the last indexes points to a latest-stored location of the corresponding index datum in the dimension table.

### CLAIM FOR PRIORITY

This application claims priority to China Patent Application No. 201910456763.X filed on May 29, 2019, which is hereby incorporated by reference in its entirety.

### CROSS-REFERENCES TO RELATED APPLICATIONS

Not applicable.

### BACKGROUND OF THE INVENTION

### Field of the Invention

The present invention relates to a data management apparatus, method, and non-transitory tangible machine-readable medium thereof. Specifically, the present invention relates to a data management apparatus, method, and non-transitory tangible machine-readable medium thereof that efficiently manage data with index.

### Descriptions of the Related Art

In recent years, due to the rapid development of network communication technology and social media, some new forms of data service requirements have been derived. These new forms of data service requirements have some major characteristics. First, the contents of data are quite diverse, so items of a piece of data are stored in multiple tables. Second, after a piece of data has been stored, it is usually that one (or more) items of that piece of data will be modified for one or more times and every version of the modified item of that piece of data has to be kept (that is, to record the footprint of the data). Third, no matter how many times that a piece of data has been modified, the last version of that piece of data is provided to the user by joining multiple tables when there is a need in providing one or more items of that piece of data to the user.

For these new forms of data service requirements, conventional database management systems (e.g., relational database management systems) cannot operate efficiently. One conventional approach is to make each table have an attribute for storing the identifier of each piece of data and then create a full index of all the data based on the identifier. However, both creating a full index and using the full index to find out the last version of data are extremely time-consuming. Another conventional approach is to make each table have an attribute for storing the time at which the piece of data is stored or modified. However, this conventional approach needs to scan all the data in order to find out the last version of a data, which is also extremely time-consuming.

### SUMMARY OF THE INVENTION

To solve various problems described in the related art, the present invention provides a data management apparatus, method, and non-transitory tangible machine-readable medium thereof that efficiently manage data with index.

The data management apparatus provided by the present invention comprises a storage and processor, wherein the processor is electrically connected to the storage. The storage is configured to store a dimension table, wherein the dimension table is defined by a plurality of attributes, and a subset of the attributes is set to be an index attribute. The dimension table comprises a plurality of members, and each of the members comprises an index datum corresponding to the index attribute. The processor is configured to create a last index for each distinct index datum among the plurality of index data, wherein each of the last indexes points to a latest-stored location of the corresponding index datum in the dimension table.

Preferably, the data management apparatus further comprises a transceiving interface, which is configured to receive a new member. The new member comprises an index datum corresponding to the index attribute, and the index datum of the new member is the same as one of the plurality of index data. The processor is further configured to store the new member in the dimension table, find out a particular last index from the last indexes according to the index datum of the new member, and update the particular last index to point to a stored location of the new member in the dimension table.

Preferably, one of the attributes of the dimension table is a comparable attribute, and the members in the dimension table and the new member each comprises a datum corresponding to the comparable attribute. The processor further locates a particular member according to the particular last index and determines that the datum corresponding to the comparable attribute is a later one comparing to the datum corresponding to the comparable attribute in the particular member. The particular last index is updated to point to the stored location of the new member in the dimension table after the processor determines that the datum corresponding to the comparable attribute in the new member is a later one comparing to the datum corresponding to the comparable attribute in the particular member.

Preferably, the storage is further configured to store a fact table. The fact table is defined by the index attribute and a data field, and the fact table comprises a plurality of fact records. The transceiving interface is further configured to receive a query command. The processor is further configured to derive a second subset of the fact table as a query table according to the query command. The processor is further configured to expand the query table to an expanded query table by performing a join operation with reference to the last indexes. The expanded query table is defined by the index attribute, the data field, and an expanding attribute, wherein the expanding attribute is one of the attributes of the dimension table.

Preferably, each of the fact records comprises an index datum corresponding to the index attribute and a fact datum corresponding to the data field. The join operation performs the following operations to each of the fact records in the query table: finding out a particular member of the dimension table according to the last index corresponded by the index datum comprised in the fact record and expanding the fact record based on a description datum comprised in the particular member.

Preferably, the processor stores the last indexes in a hash table.

The data management method provided by the present invention is adapted for use in an electronic computing apparatus. The data management method comprises a step of storing a dimension table in the electronic computing apparatus. The dimension table is defined by a plurality of attributes, and a subset of the attributes is set to be an index attribute. The dimension table comprises a plurality of members, and each of the members comprises an index datum corresponding to the index attribute. The data management method further comprises a step of creating a last index for each distinct index datum among the plurality of index data, wherein each of the last indexes points to a latest-stored location of the corresponding index datum in the dimension table.

The non-transitory tangible machine-readable medium provided by the present invention is stored with a computer program comprising a plurality of codes. The codes are executed by an electronic computing apparatus to perform a data management method when the computer program is loaded into the electronic computing apparatus. The data management method comprises a step of storing a dimension table in the electronic computing apparatus. The dimension table is defined by a plurality of attributes, and a subset of the attributes is set to be an index attribute. The dimension table comprises a plurality of members, and each of the members comprises an index datum corresponding to the index attribute. The data management method further comprises a step of creating a last index for each distinct index datum among the plurality of index data, wherein each of the last indexes points to a latest-stored location of the corresponding index datum in the dimension table.

The data management technology provided by the present invention (including the apparatus, the method, and the non-transitory tangible machine-readable medium at least) treats a subset of a plurality of attributes of the dimension table as an index attribute, and then creates a last index for the distinct index datum corresponding to the index attribute, wherein each of the last indexes points to a latest-stored location of the corresponding index datum in the dimension table. Since each of the last indexes points to a latest-stored location of the corresponding index datum in the dimension table, the last version of a member corresponding to a certain index datum can be quickly found through the last index. By creating the last index, the data management technology provided by the present invention can provide more timely responses for the new form of data service requirements.

The detailed technology and preferred embodiments implemented for the subject invention are described in the following paragraphs accompanying the appended drawings for people skilled in the art to well appreciate the features of the claimed invention.

### BRIEF DESCRIPTION OF THE DRAWINGS

FIG. 1A depicts a schematic view of a data management apparatus 1 according to a first embodiment;

FIG. 1B depicts a specific example of a dimension table 12;

FIG. 1C depicts a schematic view of the last indexes corresponding to distinct index data;

FIG. 1D depicts a specific example of updating a certain last index;

FIG. 1E depicts a specific example of a fact table 14;

FIG. 1F depicts a specific example of a query table 16 and an expanded query table 18;

FIG. 2A depicts a main flowchart of a data management method according to a second embodiment; and

FIG. 2B depicts additional processes that may be performed by a data management method in some embodiments.

### DESCRIPTION OF THE PREFERRED EMBODIMENT

In the following description, a data management apparatus, method, and non-transitory tangible machine-readable medium thereof provided by the present invention will be explained with reference to embodiments thereof. However, these embodiments of the present invention are not intended to limit the present invention to any environment, applications, or implementations described in these embodiments. Therefore, description of these embodiments is only for purpose of illustration rather than to limit the scope of the present invention. It shall be appreciated that, in the following embodiments and the attached drawings, elements unrelated to the present invention are omitted from depiction. In addition, dimensions of elements and dimensional proportions among individual elements in the attached drawings are provided only for illustration, but not to limit the scope of the present invention.

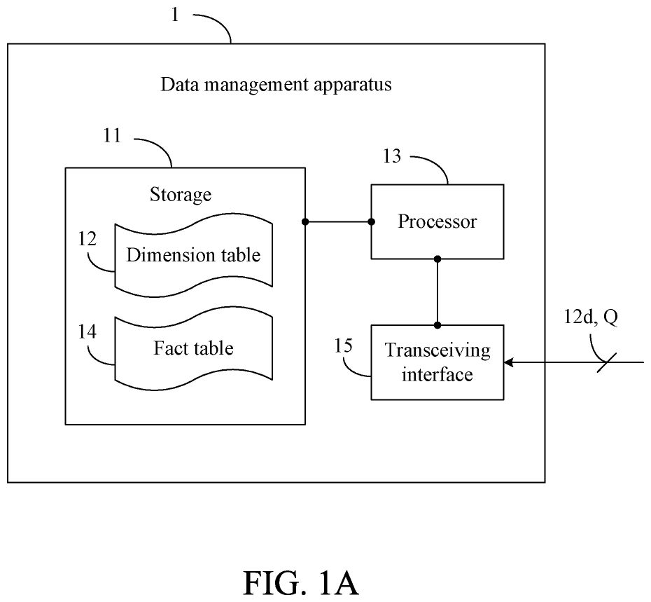

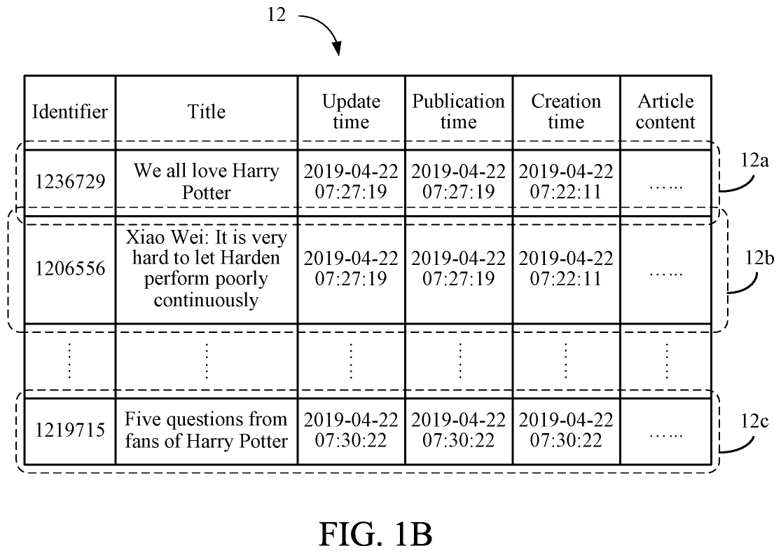

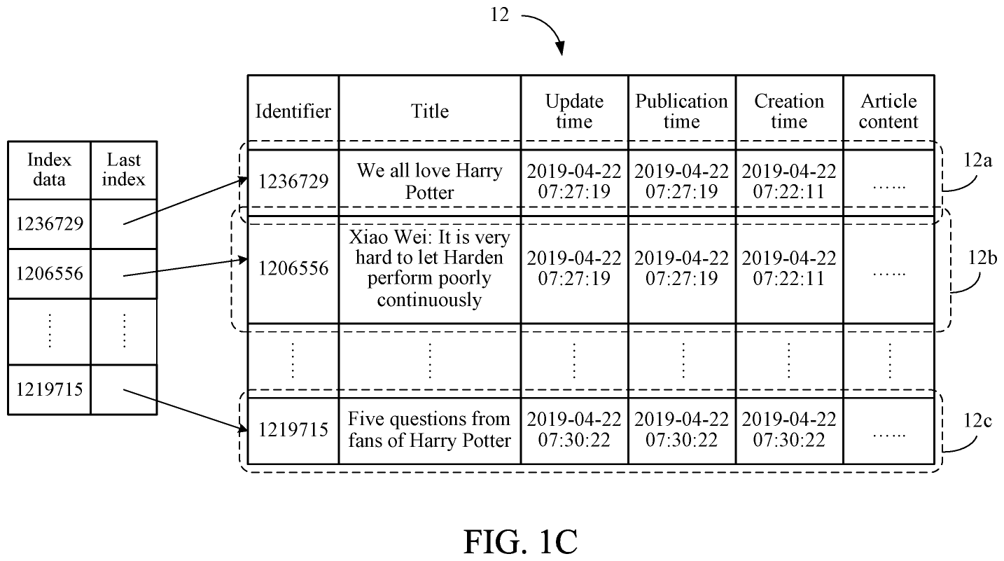

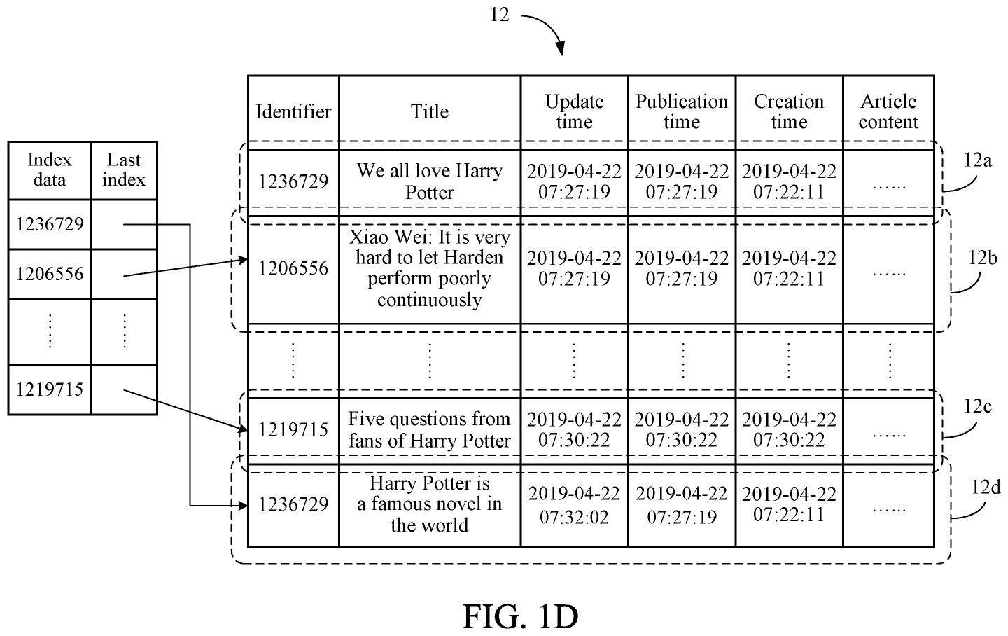

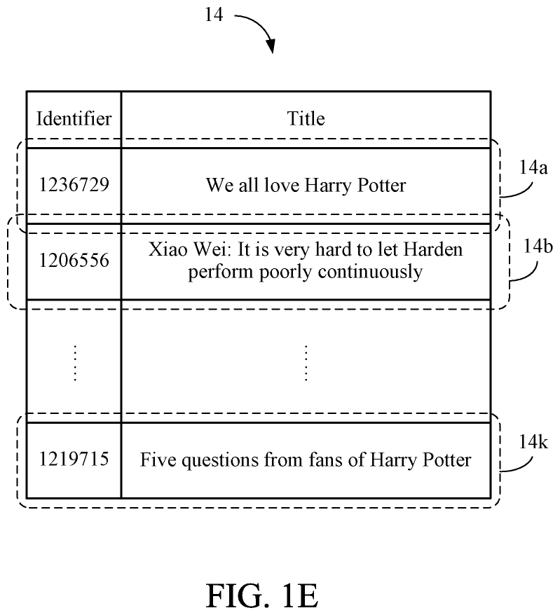

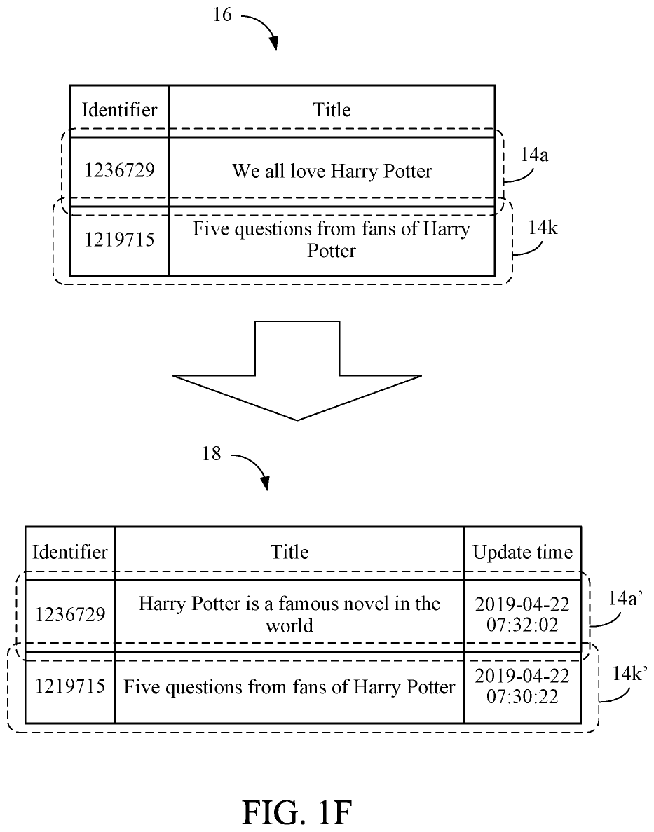

A first embodiment of the present invention is a data management apparatus 1, and a schematic view thereof is depicted in FIG. 1A. The data management apparatus 1 comprises a storage 11 and a processor 13 which is electrically connected to the storage 11. The storage 11 may be a hard disk (e.g., a solid-state hard disk) or other non-transitory storage medium or apparatus that can be installed with various data storage systems and well known to those skilled in the art. The processor 13 may be one of various processors, central processing units (CPUs), microprocessors, digital signal processors (DSPs), or any other computing apparatuses that have the same function and well known to those skilled in the art.

In some embodiments, the data management apparatus 1 may further comprise a transceiving interface 15 that is electrically connected to the processor 13. The transceiving interface 15 may be any wired or wireless interface capable of receiving and transmitting signals and data. For example, the transceiving interface 15 may be a network interface capable of connecting to a network (e.g., an Internet, a local area network, but not limited thereto) and may be an interface capable of receiving data inputted by a user (e.g., an interface capable of receiving data from a keyboard), but it is not limited thereto.

In this embodiment, the storage 11 stores a dimension table 12, and the dimension table 12 is defined by a plurality of attributes and comprises a plurality of members. It shall be noted that the present invention does not limit the number of attributes in the dimension table 12 to any specific number and does not limit the number of members comprised in the dimension table 12 to any specific number. A subset of these attributes in the dimension table 12 is set to be an index attribute (that is, the index attribute may include one or more of these attributes). It shall be appreciated that the time and the manner of setting the index attribute are not limited by the present invention. For example, a user can set one or more attributes of the dimension table 12 as the index attribute through an operation interface when the dimension table 12 is created, but it is not limited thereto. Each member of the dimension table 12 comprises a plurality of data corresponding to these attributes one-to-one, and the data corresponding to the index attribute is referred to as index data.

For understanding, please refer to a specific example shown in FIG. 1B. This specific example will be used for subsequent description, but it shall be appreciated that this specific example is not intended to limit the scope of the present invention. In the specific example shown in FIG. 1B, the dimension table 12 belongs to an article database and the dimension table 12 is defined by six attributes including an identifier, a title, an update time, a publication time, a creation time, and an article content. In addition, the dimension table 12 comprises a plurality of members 12a, 12b, . . . , 12c, and each of the members 12a, 12b, . . . , 12c has six data corresponding to the above-mentioned six attributes one-to-one. In this embodiment, the attribute “identifier” among the six attributes of the dimension table 12 is set to be an index attribute, so the data corresponding to the index attribute (i.e., the attribute “identifier”) is referred to as index data.

The processor 13 creates a last index for each distinct index datum among the plurality of index data (i.e., the data corresponding to the attribute “identifier”) of the dimension table 12, and each of the last indexes points to a latest-stored location of the corresponding index datum in the dimension table 12 as shown in FIG. 1C. Taking the last index of the index datum “1236729” as an example, it points to the latest-stored location of the index datum “1236729” in the dimension table 12, that is, the stored location of the member 12a in the dimension table 12. It shall be appreciated that the manner for recording the last index is not limited by the present invention. For example, the processor 13 may record the last indexes in a data table, a hash table, or a B-tree without being limited thereto.

In this embodiment, if the transceiving interface 15 receives a new member thereafter, the processor 13 stores the new member in the dimension table 12 and determines whether to create a new last index or update an existing last index.

Specifically, the new member comprises a plurality of data corresponding to the attributes (i.e., the identifier, the title, the update time, the publication time, the creation time, and the article content) in the dimensional table 12 one-to-one, and the datum corresponding to the index attribute (i.e., the attribute “identifier”) is referred to as the index datum. The processor 13 determines whether the index datum of the new member is the same as the index datum corresponded by any last index. It shall be appreciated that since the processor 13 has previously created the last indexes for the distinct index data in the dimension table 12, the corresponding last index of the new member can be found based on the index datum of the new member if the index datum of the new member is the same as the index datum of any of the members 12a, 12b, . . . , 12c in the dimension table 12.

In this embodiment, if the processor 13 determines that the index datum of the new member is different from the index data corresponding to all the last indexes, the processor 13 stores the new member in the dimension table 12 and creates a last index for the index datum of the new member and the last index for the new member points to the stored location of the new member in the dimension table 12.

In this embodiment, if the processor 13 determines that the index datum of the new member is the same as the index datum corresponding to a certain last index, the processor 13 stores the new member in the dimension table 12, finds out a particular last index from the last indexes previously created according to the index datum of the new member (that is, finds out the last index that corresponds to the index datum of the new member from the last indexes previously created), and updates the particular last index to point to the stored location of the new member in the dimension table 12.

FIG. 1D depicts a specific example of updating a certain last index. However, it shall be appreciated that this specific example is not intended to limit the scope of the present invention. In this specific example, the transceiving interface 15 receives the new member 12d. The processor 13 determines that the index datum of the new member 12d is the same as the index datum (that is, the index datum “1236729”) corresponding to a certain last index. Therefore, after storing the new member 12d in the dimension table 12, the processor 13 updates the last index corresponding to the index datum “1236729” to point to the stored position of the new member 12d in the dimension table 12 as shown in FIG. 1D.

In some embodiments, it is possible that the order that the data management apparatus 1 receives two members is different to the order that the two members should be. For example, it is possible that a member corresponding to an earlier event is received by the data management apparatus 1 after another member corresponding a later event has been received by the data management apparatus 1 due to various reasons (e.g. network traffic, system performance). For those embodiments, if the processor 13 determines that the index datum of the new member is the same as the index datum corresponding to a particular last index, the processor 13 further determine whether there is a need in updating that particular last index.

To be more specific, one of the attributes of the dimension table 12 is a comparable attribute (e.g. the attribute “update time”). An attribute can be treated as a comparable attribute if its corresponding data can be compared. Each of the members 12a, 12b, . . . , 12c in the dimension table 12 comprises a datum corresponding to the comparable attribute, and the new member also comprises a datum corresponding to the comparable attribute.

For those embodiments, the processor 13 stores the new member in the dimension table 12, finds out a particular last index from the last indexes previously created according to the index datum of the new member (that is, finds out the last index that corresponds to the index datum of the new member from the last indexes previously created), locates a particular member according to the particular last index, determines that the datum corresponding to the comparable attribute in the new member is a later one comparing to the datum corresponding to the comparable attribute in the particular member, and updates the particular last index to point to the stored location of the new member in the dimension table 12 after the processor determines that the datum corresponding to the comparable attribute in the new member is a later one comparing to the datum corresponding to the comparable attribute in the particular member. In this way, it is ensured that all the last indexes will point to the corresponding latest one (e.g. the corresponding latest events).

In some embodiments, the storage 11 further stores a fact table 14. The fact table is defined by an index attribute that is the same as the dimension table 12 and a data field, and the fact table 14 comprises a plurality of fact records. For understanding, please refer to a specific example shown in FIG. 1E. This example will be used for subsequent description, but it shall be appreciated that this specific example is not intended to limit the scope of the present invention. In the specific example shown in FIG. 1E, the fact table 14 also belongs to an article database, and the fact table 14 is defined by the index attribute (i.e., the attribute “identifier”) that is the same as the dimension table 12 and a data field (i.e., the attribute “title”). Moreover, the fact table 14 comprises a plurality of fact records 14a, 14b, . . . , 14k, and each of the fact records 14a, 14b, 14k comprises an index datum corresponding to the index attribute and a fact datum corresponding to the data field.

In some embodiments, the transceiving interface 15 or another transceiving interface (not shown) receives a query command Q to query the fact table 14. Then, the processor 13 derives a subset of the fact table 14 as a query table 16 according to the query command Q. For example, if the query command Q carries a keyword, the processor 13 may retrieve the fact record(s) that has the keyword therein from the fact table 14 as the query table 16. After deriving the query table 16, the processor 13 performs a join operation with reference to the last index previously created and thereby expanding the query table 16 to an expanded query table 18. The expanded query table 18 is defined by the index attribute, the data field, and an expanding attribute, and the expanding attribute is one of the attributes of the dimension table. It shall be noted that the expanding attribute used for expanding the query table 16 may be preset or be recorded in the query command Q.

In more detail, the join operation performed by the processor 13 executes the following operations to each of the fact records in the query table 16: (a) finding out a particular member of the dimension table 12 according to the last index corresponded by the index datum comprised in the fact record and (b) expanding the fact record based on the description datum comprised in the particular member (i.e., the datum corresponding to the expanding attribute).

A specific example is provided herein for understanding, but it shall be appreciated that this specific example is not intended to limit the scope of the present invention. Please refer to FIG. 1D and FIG. 1F. In this specific example, the query command Q carries a keyword “Harry Potter” and an expanding attribute “Update Time.” The processor 13 retrieves the fact records 14a and 14k that has the keyword therein from the fact table 14 as the query table 16 according to the keyword carried in the query command Q. Then, the processor 13 performs a join operation with reference to the last index previously created and thereby expanding the query table 16 into the expanded query table 18. The expanded query table 18 is defined by the index attribute (i.e., the attribute “identifier”), the data field (i.e., the attribute “title”), and the expanding attribute (i.e., the attribute “update time”) and comprises fact records 14a′ and 14k′ corresponding to the fact records 14a and 14k respectively.

Specifically, for the fact record 14a in the query table 16, the processor 13 finds out a particular member (i.e., the member 12d) in the dimension table 12 according to the last index corresponding to the index datum (i.e., 1236729) comprised in the fact record 14a. That is, according to the last index corresponding to the index datum (i.e., 1236729) comprised in the fact record 14a, the processor 13 finds out the last version among all the members in the dimension table 12 that corresponds to the index datum (i.e., 1236729). The processor 13 then expands the fact record 14a based on the description datum (i.e., the datum corresponding to the expanding attribute) comprised in this particular member (i.e., the member 12d). In addition, the processor 13 further determines that the dimension table 12 has an attribute that is the same as the data field in the query table 16 (that is, the attribute “title”), and therefore updates the fact record 14a based on the datum corresponding to the attribute “title” of this particular member (i.e., the member 12d). After these operations, the processor 13 can obtain the fact record 14a′ in the expanded query table 18. Likewise, the processor 13 performs similar operations for the fact record 14k in the query table 16 to obtain the fact record 14k′ in the expanded query table 18, and the details will not be repeated.

From the above description, the data management apparatus 1 retains the data footprint of the dimension table 12 (that is, the past member will not be deleted, and data of the past member will not be overwritten) and creates a last index for the distinct index data in the dimension table 12. Since each of the last indexes points to a latest-stored location of the corresponding index datum in the dimension table 12, the data management apparatus 1 can quickly find out the last version of a member corresponding to a certain index datum through the last index. By creating the last index, the data management apparatus 1 can provide more timely responses for the new form of data service requirements.

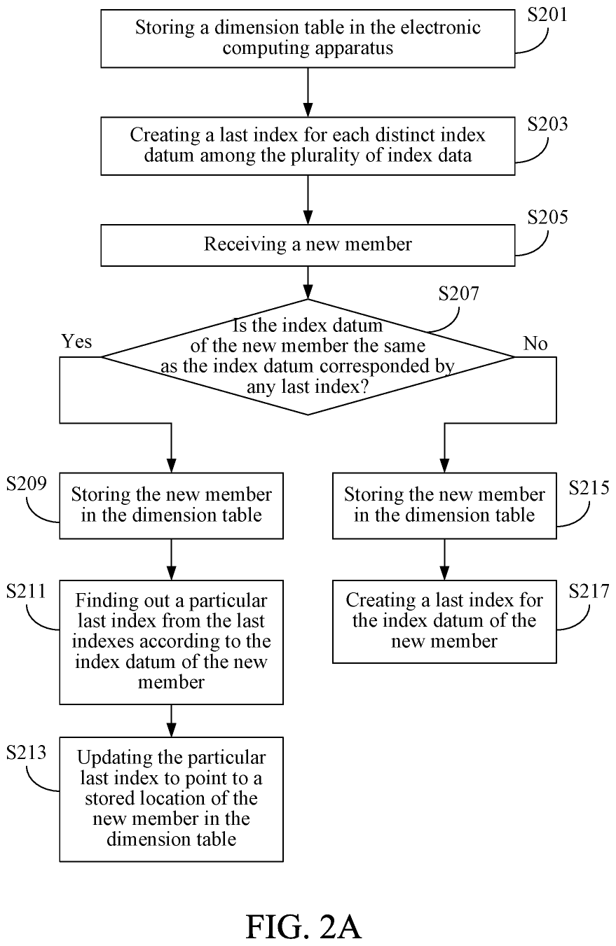

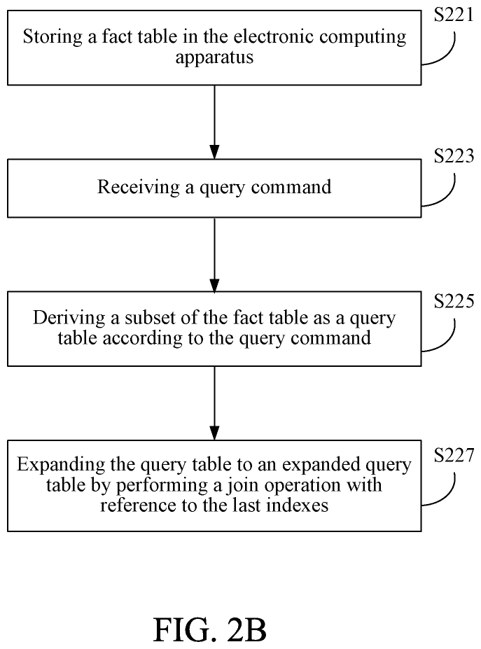

A second embodiment of the present invention is a data management method, and a main flowchart thereof is depicted in FIG. 2A. The data management method is adapted for use in an electronic computing apparatus, e.g., the data management apparatus 1 of the first embodiment. The data management method executes steps S201 to S203.

In the step S201, a dimension table is stored in the electronic computing apparatus, wherein the dimension table is defined by a plurality of attributes, and a subset of the attributes is set to be an index attribute. The dimension table comprises a plurality of members, and each of the members comprises an index datum corresponding to the index attribute. In the step S203, the electronic computing apparatus creates a last index for each distinct index datum among the plurality of index data, wherein each of the last indexes points to a latest-stored location of the member in the dimension table to which the corresponding index datum belongs.

In some embodiments, the data management method further executes steps S205 to S217. In the step S205, the electronic computing apparatus receives a new member, wherein the new member comprises an index datum corresponding to the index attribute. In the step S207, the electronic computing apparatus determines whether the index datum of the new member is the same as the index datum corresponded by any last index.

If the determination result of the step S207 is yes (which means that the index datum of the new member is the same as one of the index data of the members, so the index datum corresponded by a last index is the same as the index data of the new member), the electronic computing apparatus executes steps S209 to S213. In the step S209, the electronic computing apparatus stores the new member in the dimension table. In the step S211, the electronic computing apparatus finds out a particular last index from the last indexes according to the index datum of the new member. In the step S213, the electronic computing apparatus updates the particular last index to point to a stored location of the new member in the dimension table.

If the determination result of the step S207 is no, the electronic computing apparatus then executes steps S215 to S217. In the step S215, the electronic computing apparatus stores the new member in the dimension table. In the step S217, the electronic computing apparatus creates a last index for the index datum of the new member, and the last index of the new member points to the stored location of the new member in the dimension table.

In some embodiments, it is possible that the order that the data management apparatus 1 receives two members is different to the order that the two members should be. For example, it is possible that a member corresponding to an earlier event is received by the electronic computing apparatus after another member corresponding a later event has been received by the electronic computing apparatus due to various reasons (e.g. network traffic, system performance). For those embodiments, if the step S207 determines that the index datum of the new member is the same as the index datum corresponding to a particular last index, the data management method further determine whether there is a need in updating that particular last index.

To be more specific, one of the attributes of the dimension table is a comparable attribute. An attribute can be treated as a comparable attribute if its corresponding data can be compared. Each of the members in the dimension table comprises a datum corresponding to the comparable attribute, and the new member also comprises a datum corresponding to the comparable attribute.

For those embodiments, the data management method executes the step S209 for storing the new member in the dimension table, the step S211 for finding out a particular last index from the last indexes previously created according to the index datum of the new member, a step for locating a particular member according to the particular last index (not shown), a step for determining that the datum corresponding to the comparable attribute in the new member is a later one comparing to the datum corresponding to the comparable attribute in the particular member (not shown), and the step S213 for updating the particular last index to point to the stored location of the new member in the dimension table after the step for determining that the datum corresponding to the comparable attribute in the new member is a later one comparing to the datum corresponding to the comparable attribute in the particular member. In this way, it is ensured that all the last indexes will point to the corresponding latest one (e.g. the corresponding latest events).

In some embodiments, the data management method may further execute the additional processes depicted in FIG. 2B. Specifically, step S221 is executed for storing a fact table in the electronic computing apparatus, wherein the fact table is defined by the index attribute and a data field. The fact table comprises a plurality of fact records, wherein each of the fact records comprises an index datum corresponding to the index attribute and a fact datum corresponding to the data field. In step S223, the electronic computing apparatus receives a query command. In step S225, the electronic computing apparatus derives a subset of the fact table as a query table according to the query command. In the step S225, the electronic computing apparatus expands the query table to an expanded query table by performing a join operation with reference to the last indexes, wherein the expanded query table is defined by the index attribute, the data field, and an expanding attribute and the expanding attribute is one of the attributes of the dimension table.

In some embodiments, the join operation performs the following steps to each of the fact records in the query table: (a) finding out a particular member in the dimension table according to the last index corresponded by the index datum comprised in the fact record and (b) expanding the fact record based on a description datum comprised in the particular member.

In addition to the aforesaid steps, the second embodiment can execute all the operations and steps of the data management apparatus 1 set forth in the first embodiment, have the same functions, and deliver the same technical effects as the first embodiment. How the second embodiment executes these operations and steps, has the same functions, and delivers the same technical effects as the first embodiment will be readily appreciated by those of ordinary skill in the art based on the explanation of the first embodiment, and thus will not be further described herein.

The data management method described in the second embodiment may be implemented by a computer program having a plurality of codes. After the computer program is loaded into an electronic computing apparatus, the electronic computing apparatus executes the codes to perform the data management method described in the second embodiment. The computer program is stored in a non-transitory tangible machine-readable medium. The non-transitory tangible machine-readable medium may be an electronic product, e.g., a read only memory (ROM), a flash memory, a floppy disk, a hard disk, a compact disk (CD), a digital versatile disc (DVD), a mobile disk, or any other storage medium with the same function and well known to those skilled in the art.

From the above description of the embodiments, the data management technology (including the apparatus, the method, and the non-transitory tangible machine-readable medium at least) provided by the present invention retains the data footprint of the dimension table (that is, the past member will not be deleted, and data of the past member will not be overwritten) and creates a last index for the distinct index data in the dimension table. Since each of the last indexes points to a latest-stored location of the corresponding index datum in the dimension table, the data management technology provided by the present invention can quickly find out the last version of a member corresponding to a certain index datum through the last index. By creating the last index, the data management technology provided by the present invention can provide more timely responses for the new form of data service requirements.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data management apparatus, comprising:
a storage, being configured to store a dimension table, wherein the dimension table is defined by a plurality of attributes, a first subset of the attributes is set to be an index attribute, the dimension table comprises a plurality of members, and each of the members comprises an index datum corresponding to the index attribute; and
a processor electrically connected with the storage, being configured to create a last index for each distinct index datum among the plurality of index data, wherein each of the last indexes points to a latest-stored location of the corresponding index datum in the dimension table.

2. The data management apparatus of claim 1, further comprising:
a transceiving interface, being configured to receive a new member, the new member comprising an index datum corresponding to the index attribute, and the index datum of the new member being the same as one of the plurality of index data;
wherein the processor is further configured to store the new member in the dimension table, find out a particular last index from the last indexes according to the index datum of the new member, and update the particular last index to point to a stored location of the new member in the dimension table.

3. The data management apparatus of claim 2, wherein one of the attributes of the dimension table is a comparable attribute, the members in the dimension table and the new member each comprises a datum corresponding to the comparable attribute, the processor further locates a particular member according to the particular last index, the processor further determines that the datum corresponding to the comparable attribute in the new member is a later one comparing to the datum corresponding to the comparable attribute in the particular member, and the particular last index is updated to point to the stored location of the new member in the dimension table after the processor determines that the datum corresponding to the comparable attribute in the new member is a later one comparing to the datum corresponding to the comparable attribute in the particular member.

4. The data management apparatus of claim 3, wherein the storage is further configured to store a fact table, the fact table is defined by the index attribute and a data field, and the fact table comprises a plurality of fact records,
wherein the transceiving interface is further configured to receive a query command, the processor is further configured to derive a second subset of the fact table as a query table according to the query command, the processor is further configured to expand the query table to an expanded query table by performing a join operation with reference to the last indexes,
wherein the expanded query table is defined by the index attribute, the data field, and an expanding attribute, and the expanding attribute is one of the attributes of the dimension table.

5. The data management apparatus of claim 4, wherein each of the fact records comprises an index datum corresponding to the index attribute and a fact datum corresponding to the data field, and the join operation performs the following operations to each of the fact records in the query table:
finding out a particular member of the dimension table according to the last index corresponded by the index datum comprised in the fact record, and
expanding the fact record based on a description datum comprised in the particular member.

6. The data management apparatus of claim 1, wherein the processor stores the last indexes in a hash table.

7. A data management method for an electronic computing apparatus, comprising the following steps of:
storing a dimension table in the electronic computing apparatus, wherein the dimension table is defined by a plurality of attributes, a first subset of the attributes is set to be an index attribute, the dimension table comprises a plurality of members, and each of the members comprises an index datum corresponding to the index attribute; and
creating a last index for each distinct index datum among the plurality of index data, wherein each of the last indexes points to a latest-stored location of the corresponding index datum in the dimension table.

8. The data management method of claim 7, further comprising the following steps of:
receiving a new member, wherein the new member comprises an index datum corresponding to the index attribute and the index datum of the new member is the same as one of the plurality of index data;
storing the new member in the dimension table;
finding out a particular last index from the last indexes according to the index datum of the new member; and
updating the particular last index to point to a stored location of the new member in the dimension table.

9. The data management method of claim 7, wherein one of the attributes of the dimension table is a comparable attribute, the members in the dimension table and the new member each comprises a datum corresponding to the comparable attribute, and the data management method further comprises the following steps of:
locating a particular member according to the particular last index; and
determining that the datum corresponding to the comparable attribute in the new member is a later one comparing to the datum corresponding to the comparable attribute in the particular member,
wherein the step of updating the particular last index is executed after the step of determining that the datum corresponding to the comparable attribute in the new member is a later one comparing to the datum corresponding to the comparable attribute in the particular member.

10. The data management method of claim 9, further comprising the following steps of:
storing a fact table in the electronic computing apparatus, wherein the fact table is defined by the index attribute and a data field, and the fact table comprises a plurality of fact records;
receiving a query command;
deriving a second subset of the fact table as a query table according to the query command; and
expanding the query table to an expanded query table by performing a join operation with reference to the last indexes, wherein the expanded query table is defined by the index attribute, the data field, and an expanding attribute, and the expanding attribute is one of the attributes of the dimension table.

11. The data management method of claim 10, wherein each of the fact records comprises an index datum corresponding to the index attribute and a fact datum corresponding to the data field, and the join operation performs the following steps to each of the fact records in the query table:
finding out a particular member of the dimension table according to the last index corresponded by the index datum comprised in the fact record; and
expanding the fact record based on a description datum comprised in the particular member.

12. The data management method of claim 7, wherein the last indexes are stored in a hash table.

13. A non-transitory tangible machine-readable medium, being stored with a computer program, the computer program comprising a plurality of codes, the codes being able to execute a data management method when the computer program is loaded into an electronic computing apparatus, the data management method comprising the following steps of:
storing a dimension table in the electronic computing apparatus, wherein the dimension table is defined by a plurality of attributes, a first subset of the attributes is set to be an index attribute, the dimension table comprises a plurality of members, and each of the members comprises an index datum corresponding to the index attribute; and
creating a last index for each distinct index datum among the plurality of index data, wherein each of the last indexes points to a latest-stored location of the corresponding index datum in the dimension table.

14. The non-transitory tangible machine-readable medium of claim 14, wherein the data management method further comprises the following steps of:
receiving a new member, wherein the new member comprises an index datum corresponding to the index attribute and the index datum of the new member is the same as one of the plurality of index data;
storing the new member in the dimension table;
finding out a particular last index from the last indexes according to the index datum of the new member; and
updating the particular last index to point to a stored location of the new member in the dimension table.

15. The non-transitory tangible machine-readable medium of claim 14, wherein one of the attributes of the dimension table is a comparable attribute, the members in the dimension table and the new member each comprises a datum corresponding to the comparable attribute, and the data management method further comprises the following steps of:
locating a particular member according to the particular last index; and
determining that the datum corresponding to the comparable attribute in the new member is a later one comparing to the datum corresponding to the comparable attribute in the particular member,
wherein the step of updating the particular last index is executed after the step of determining that the datum corresponding to the comparable attribute in the new member is a later one comparing to the datum corresponding to the comparable attribute in the particular member.

16. The non-transitory tangible machine-readable medium of claim 15, wherein the data management method further comprises the following steps of:
storing a fact table in the electronic computing apparatus, wherein the fact table is defined by the index attribute and a data field, and the fact table comprises a plurality of fact records;
receiving a query command;
deriving a second subset of the fact table as a query table according to the query command; and
expanding the query table to an expanded query table by performing a join operation with reference to the last indexes, wherein the expanded query table is defined by the index attribute, the data field, and an expanding attribute, and the expanding attribute is one of the attributes of the dimension table.

17. The non-transitory tangible machine-readable medium of claim 16, wherein each of the fact records comprises an index datum corresponding to the index attribute and a fact datum corresponding to the data field, and the join operation performs the following steps to each of the fact records in the query table:
finding out a particular member of the dimension table according to the last index corresponded by the index datum comprised in the fact record; and
expanding the fact record based on a description datum comprised in the particular member.

18. The non-transitory tangible machine-readable medium of claim 13, wherein the last indexes are stored into a hash table.
